(19) United States
(12) Patent Application Publication
(10) Pub. No.: US 2019/0192984 A1
(43) Pub. Date: Jun. 27, 2019

(54) LATEX BALLOONS HAVING REFLECTIVE METALLIC APPEARANCE AND PROCESS OF MAKING THE SAME

(71) Applicant: CONTINENTAL AMERICAN CORPORATION D/B/A PIONEER BALLOON COMPANY, Wichita, KS (US)

(72) Inventors: John Holmes, Loudonville, OH (US); Gerard Maratta, Staten Island, NY (US)

(21) Appl. No.: 15/853,374

(22) Filed: Dec. 22, 2017

(51) Int. Cl. A63H 27/10; C08K 3/08; C08L 7/02

(52) U.S. Cl. CPC A63H 27/10; C08K 3/08; C08L 7/02; A63H 2027/1025; C08K 2003/0812; C08K 2003/0862; C08K 2003/0881; C08K 2003/0875; C08K 2003/0806; C08K 2003/0893; C08K 2003/0831; C08K 2003/085; C08K 2003/0856

(57) ABSTRACT

In a first aspect, the invention is directed to a balloon made from a latex composition comprising latex and a metal or metal alloy. In a second aspect, the invention is directed to a process for making such a latex composition.

### CROSS-REFERENCE TO RELATED APPLICATIONS

Not Applicable.

### STATEMENT REGARDING FEDERALLY SPONSORED RESEARCH OR DEVELOPMENT

Not applicable.

### STATEMENT REGARDING JOINT RESEARCH AGREEMENT

Not applicable.

### BACKGROUND OF THE INVENTION

### 1. Field of the Invention

The present invention relates generally to the field of latex balloons and is more specifically directed to a latex composition and balloons made therefrom having a reflective metallic appearance.

### 2. Description of Related Art

Decorative and toy balloons are typically made from a natural rubber or synthetic latex (“latex balloons”) or from a metalized film (“foil balloons”). The balloons are made in a variety of different shapes, sizes, and colors, and can include graphics or wording imprinted on their outer surfaces using various techniques known in the art.

To produce a latex balloon, forms or formers as is known in the art in the shape of the un-inflated balloon are dipped into a latex composition so as to coat the formers. The coating on the former is then vulcanized (e.g. by removing the water and cross-linking the polyisoprene chains of the natural rubber latex) to transform the latex into a solid latex rubber balloon. The latex is commonly pigmented with a desired color before the dipping step by mixing pigment with the latex. In the past, latex balloon manufacturers have attempted to simulate a metallic finish on latex balloons by mixing a mica pigment with the latex. While these “pearl” or “metaltone” balloons are attractive, most have a relatively dull appearance as compared to the highly reflective appearance commonly associated with metallic finishes. The balloons made with mica pigment also are fairly transparent and therefore have limited color intensity. While the balloons can be made more opaque with greater color intensity by dipping the balloon form into the latex composition multiple times or by including additional components into the latex such as additional mica or other pigments, those efforts increase the cost of production and potentially have a deleterious impact on other physical properties of the latex composition and balloons made therefrom.

It has also been noted that latex balloons made with a mica pigment tend to have reduced inflateability (they do not expand as much when inflated) and also have a reduced “flight time” (they do not hold the air or helium as long after inflation) as latex balloons that do not include the mica pigment.

### BRIEF SUMMARY OF THE INVENTION

In a first aspect, the present invention is directed to a latex composition and an inflatable decorative or toy balloon made from a latex composition comprising a mixture of: (1) a latex material, and (2) one or more metals and/or metal alloys. The metals and/or metal alloys in the mixture are provided in pure or elemental form, as opposed to being incorporated into compounds such as minerals (e.g., mica). The latex composition of the present invention results in a balloon that is much more reflective and opaque—resulting in greater color intensity—than the “metaltone” balloons known in the past made using a mica pigment.

The metals and/or metal alloys may be any metal and/or metal alloys that are relatively highly reflective such as aluminum, nickel, iron, chromium, tin, antimony, magnesium, indium, platinum, silver, rhodium, palladium, zinc, cadmium, copper, gold, zinc, lead, titanium and alloys made therefrom. The metals and/or metal alloys preferably have a particle size ranging from about 1 to 50 microns and/or are in the form of platelets or flakes having a relatively flat configuration (as opposed to spheres or cubes). In certain embodiments of the first aspect of the invention, the one or more metals and/or metal alloys are selected from the group consisting of aluminum, nickel, iron, copper, lead, zinc, chromium, tin and alloys made therefrom, with aluminum and aluminum alloys being preferred and with aluminum being most preferred. The metals and/or metal alloys are also preferably passivated to reduce their reactivity during the production of the mixture and the balloons. In certain embodiments, the one or more metals and/or metal alloys are present in the mixture at a concentration of at least about 1% (w/v) of the latex composition. In one embodiment, the one or more metals and/or metal alloys are present in the mixture at a concentration ranging from 1 to 20%, in another embodiment from 1 to 10%, and in another embodiment ranging from 1 to 5% (w/v) of the latex composition.

The latex material may be any natural or synthetic elastic material now known or later developed in the art that can be formed into an inflatable decorative or toy balloon. In an embodiment of the first aspect of the invention, the latex material is selected from the group consisting of natural rubber latex (NRL), synthetic latex and combinations thereof. The synthetic latex is preferably an elastomeric material simulating the properties of NRL, and is most preferably selected from the group consisting of polyisoprene, neoprene, chloroprene, polychloroprene, and combinations thereof.

In a second aspect, the present invention is directed to an inflatable decorative or toy balloon formed from a latex composition prepared by a process that includes the steps of: 1) providing a latex component, one or more weak acids, one or more passivated metals and/or metal alloys, and one or more chelating agents; 2) mixing the one or more passivated metals and/or metal alloys in water to prepare an aqueous metal pigment slurry; 3) combining the aqueous metal pigment slurry with one or more chelating agents to form a first mixture; 4) combining the latex component and the one or more weak acids to form a second mixture; and 5) mixing the first mixture with the second mixture to form the latex composition. This unique process enables the pure or elemental metal and/or metal alloys to be incorporated into the latex composition during the production process (prior to dipping the forms into the latex composition and forming the balloons) without unwanted reactions that could negatively impact the physical properties of the latex composition and balloons or that could create a safety risk.

The latex component may be any natural or synthetic elastic material now known or later developed in the art that can be formed into an inflatable decorative or toy balloon. In an embodiment of this second aspect of the invention, the latex material is selected from the group consisting of NRL, synthetic latex and combinations thereof. The synthetic latex is preferably an elastomeric material simulating the properties of NRL, and is most preferably selected from the group consisting of polyisoprene, neoprene, chloroprene, polychloroprene, and combinations thereof.

The metals and/or metal alloys used in the process may be any passivated metals or alloys that have a reflective appearance such as passivated aluminum, nickel, iron, chromium, tin, antimony, magnesium, indium, platinum, silver, rhodium, palladium, zinc, cadmium, copper, gold, zinc, lead, titanium and alloys made therefrom. In one embodiment, the one or more passivated metals and metal alloys are provided in a powder form. The metals and/or metal alloys provided preferably have a particle size of 1 to 50 microns and are preferably provided in the form of platelets or flakes having a relatively flat configuration (as opposed to spheres or cubes). In certain embodiments of the first aspect of the invention, the one or more passivated metals and/or metal alloys are selected from the group consisting of passivated aluminum, nickel, iron, copper, lead, zinc, chromium, tin and alloys made therefrom, with passivated aluminum and aluminum alloys being preferred and with aluminum being most preferred. In certain embodiments of the second aspect of the present invention, the concentration of the one or more passivated metals and metal alloys in the first mixture is preferably 10 to 50% (w/v), more preferably 20 to 40% (w/v), and most preferably 25 to 30% (w/v).

The one or more chelating agents may be any agent capable of chelating any unpassivated metal ions in the first mixture. In certain embodiments, the one or more chelating agents is selected from the group consisting of ethylenediaminetetraacetic acid, neoalkoxy titanate, or combinations thereof. The amount of chelating agent utilized is preferably sufficient to chelate any unpassivated metal ions in the first mixture.

The one or more weak acids may be any weak acids now or hereafter known in the art. In certain embodiments, the one or more weak acids is preferably selected from the group consisting of boric acid, glycine, carbonic acid, acetic acid, phosphoric acid, oxalic acid, hydrofluoric acid or combinations thereof. More preferably, the one or more weak acids is selected from the group consisting of boric acid, glycine, or combinations thereof. In certain embodiments of the second aspect of the present invention, the second mixture is adjusted to a pH of preferably approximately 9.0 to 10, more preferably 9.3 to 9.9, and most preferably 9.45 to 9.8.

In certain embodiments of the second aspect of the present invention, the latex composition includes about 5 to 15% by wet weight of the first mixture, more preferably 6 to 12% by wet weight of the first mixture, and most preferably 7.5 to 10.5% by wet weight of the first mixture.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### DETAILED DESCRIPTION OF PREFERRED EMBODIMENT

The present invention is directed to an inflatable decorative or toy balloon that is made from a latex composition comprising a mixture of a latex material and one or more metals and/or metal alloys. The metals and/or metal alloys in the mixture are provided in pure or elemental form, as opposed to being incorporated into compounds such as minerals. It is also preferred that the inflatable decorative or toy balloon of the present invention does not include the mineral mica as it is believed the mica negatively impacts the inflateability and opacity.

The one or more metals or metal alloys are preferably in the form of relatively flat platelets or flakes which are believed to assist in creating the highly reflective and opaque appearance of the balloons. The one or more metals and/or metal alloys are preferably present in the latex composition at a concentration of at least 1% (w/v) of the composition preferably ranging from 1 to 20% (w/v), more preferably ranging from 1 to 10% (w/v) of the mixture, and most preferably ranging from 1 to 5% (w/v) of the mixture.

Suitable metals or metal alloys may include any elemental metal or metal alloy having a reflective appearance such as aluminum, nickel, iron, chromium, tin, antimony, magnesium, indium, platinum, silver, rhodium, palladium, zinc, cadmium, copper, gold, zinc, lead, titanium and alloys made therefrom. Aluminum, nickel, iron, lead, zinc, chromium, tin and alloys made therefrom are preferred, with aluminum and aluminum alloys being more preferred, and aluminum most preferred. Aluminum is considered particularly well suited for purposes of the present invention because it is relatively highly reflective, is relatively soft, is relatively inexpensive and is readily available. It is believed that using a relatively soft metal like aluminum assists in making the balloon more inflatable (it can be inflated with more air) than the “metaltone” balloons made using mica pigments.

Many metals including aluminum are highly reactive with water which could result in unwanted reactions and side products in the balloon making process. To reduce these reactions during the manufacture of the balloon, it is preferable to use passivated metals or metal alloys as described more fully below.

Suitable latex materials include any elastic material now known or hereafter developed in the art that can be formed into an inflatable decorative or toy balloon. Suitable latex materials include natural rubber latex (“NRL”), synthetic latex and combinations thereof. The synthetic latex is preferably an elastomeric material simulating the properties of NRL. Suitable synthetic latex materials include, but are not necessarily limited to, polyisoprene, neoprene, chloroprene, polychloroprene, and combinations thereof.

The latex composition used to form the balloon is preferably made using a unique process developed by the inventors. This process includes the following steps: (1) providing a latex component; (2) providing one or more weak acids, one or more passivated metals and/or metal alloys, and one or more chelating agents; (3) mixing the one or more passivated metals and metal alloys in water to prepare an aqueous metal pigment slurry; (4) combining the aqueous metal pigment slurry with the one or more chelating agent to form a first mixture; (5) combining the latex component and one or more weak acids to form a second mixture; and (6) mixing the first mixture with the second mixture to form the latex composition. As discussed earlier, the metals and/or metal alloys are provided in pure or elemental form and not as part of a compound such as a mineral. It is also preferred that mica is not utilized in this process.

Any of the latex materials or passivated metals and metal alloys described above in connection with the inflatable or decorative balloon of the present invention can be utilized in the process. Passivated metals are metals that have been treated to reduce their ability to corrode, oxidize or otherwise react and/or that have naturally formed an outer protective layer that reduces their ability to react. The inventors have determined that the use of passivated metals is important to reduce the risk of the generation of hydrogen gas and potentially other side products during the production of the balloons. Suitable passivated metals for use in the instant invention will have reduced reactivity in water as compared to metals that are not passivated. As discussed below, additional components and steps of the process and products of the instant invention serve to further reduce the reactivity of the metal during the production of the balloons.

Suitable methods of passivation include any means generally known in the art and any proprietary methods utilized by manufacturers of passivated metals. Known methods include, but are not necessarily limited to, chromate conversion coating, anodizing, and phosphate conversion. Ultimately, the method of passivation utilized may depend on the metal being treated.

Any reflective metal or combinations of reflective metals that can be passivated are suitable for use in the process developed by the inventors. Preferably, the passivated metal is in powder form, and may optionally be a compacted powder in pellet form. Preferably, the particles of the passivated metal will have a particle size of 1 to 50 microns. Preferably, the particles of the passivated metal will be in the form of relatively flat platelets or flakes. It is believed that these preferred sizes and/or shapes of the metal and/or metal alloys may assist in enhancing the opaqueness, inflateability and/or flight times of the balloons.

Preferably, the passivated metal utilized is softer than mica, as it is thought that this will ultimately will reduce the stiffness and improve the elasticity of the latex composition. One passivated aluminum that is considered particularly suitable for the present invention is Compal 4474 BL 25026, manufactured by Sun Chemical.

Suitable weak acids for use in the process of the present invention include any one or more weak acids that will not be disruptive to the desired properties of the latex composition of the present invention and will be determined at least in part by the latex materials used. A suitable weak acid will lower the pH of the latex material in order to reduce the number of hydrogen ions that would be available to react with the metal, which in turn imparts stability on the metal in the latex composition of the present invention than it would not otherwise have. Suitable weak acids include, but are not limited to boric acid, glycine, carbonic acid, acetic acid, phosphoric acid, oxalic acid, hydrofluoric acid or combinations thereof. Of those weak acids, boric acid and glycine are the most preferred.

Suitable chelating agents will serve to chelate unpassivated, exposed or free metal ions present in the first mixture without reacting with other components utilized in the process of the present invention. The chelating agent aids in preventing those metal ions from reacting with the water or any hydrogen ions present in the latex component. Suitable chelating agents include, but are not limited to, ethylenediaminetetraacetic acid (EDTA) and neoalkoxy titanate.

Certain exemplary embodiments of the process of the present invention will now be described in more detail.

Passivated metal, preferably aluminum, is mixed in water to prepare an aqueous metal pigment slurry. The resulting aqueous metal pigment slurry is thoroughly mixed for eight hours or less at a temperature not to exceed 120 degrees Fahrenheit. The concentration of the metal in the first mixture is 10-50% (w/v), more preferably 20-40% (w/v), and most preferably 25-30% (w/v).

The aqueous metal pigment slurry is combined with one or more chelating agents to form a first mixture. The chelating agent will chelate any unpassivated, exposed or free metal ions. The concentration of chelating agent utilized will be that which will chelate most or all of those metal ions in solution. The concentration is preferably at least a 0.8:1 molar ratio of chelating agent to predicted metal ions, more preferably a 1:1 molar ratio, and more preferably greater than 1:1 molar ration. The first mixture is then thoroughly mixed at a temperature not to exceed 180 degrees Fahrenheit.

A latex component consisting of NRL, synthetic latex, or combinations thereof is/are combined with one or more weak acids to form a second mixture in order to reduce the pH of the second mixture. The pH of the second mixture is preferably reduced to approximately 9.0 to 10, more preferably 9.3 to 9.9, and most preferably 9.45 to 9.8.

The first mixture containing the metal slurry and the second mixture containing the latex are combined to form a latex composition having about 5 to 15% by wet weight of the first composition, more preferably about 6 to 12% of the first composition, and most preferably about 7.5 to 10.5% of the first composition. The latex composition is thoroughly mixed at room temperature. It should be understood that additional components may be added to the latex composition to impart the desired physical properties and appearance to the latex and/or balloons therefrom, including additional pigments to provide a specified color and plasticizers to enhance the elasticity of the balloons. Once the latex composition is made, it can be used in forming inflatable decorative and toy balloons of varying sized and shapes using techniques and processes well known in the art and/or hereafter developed. For example, the balloons may be made using conventional dipping processes wherein forms or formers are dipped into a vessel containing the latex composition so as to coat the form. The coating on the form is then vulcanized (removing water and crosslinking the polymeric chains) to produce the solid latex rubber balloon.

The latex composition and balloons made therefrom of the present invention have certain enhanced properties as compared to previously known latex mica mixtures developed to simulate a metallic finish. These enhanced properties include, but are not necessarily limited to, improved reflectiveness, improved elasticity/elongation, improved opacity, and improved color intensity. In addition, it has been surprisingly found that balloons made from the latex composition of the present invention have increased flight times and can be inflated to larger sizes than balloons made from a latex material containing mica. Inflatable balloons prepared with the latex material of the present invention can be inflated to a larger overall size or volume—in some cases approximately 10-15% more—than balloons made from latex containing mica. For example, if an 11-inch balloon former is utilized to manufacture a balloon from the latex composition of the present invention, the balloon can be inflated a full 11 inches in diameter without distortion. Whereas, if an 11-inch balloon former is utilized to manufacture a balloon from a latex composition having mica, the balloon may begin to distort if inflated over 9 inches (without the use of plasticizers that could negatively impact other properties of the composition). Moreover, balloons made with the latex material of the present invention have longer flight times in some cases approximately 20-30% longer, than balloons made from latex containing mica. Flight testing demonstrates that the flight time of balloons made with the latex material of the present invention are approximately 30 hours, while the flight time of balloons made from latex containing mica have flight times of approximately 24 hours. The opacity of the balloons are also greatly improved wherein exemplary balloons made with a single dip into the latex composition of the present invention are nearly fully opaque (non-transparent), while balloons made with a single dip into latex containing mica are much more transparent.

### Example 1

An inflatable decorative or toy balloon made from a latex composition comprising a mixture of (1) a latex material selected from the group consisting of natural rubber latex, synthetic latex and combinations thereof, and (b) one or more metals and/or metal alloys selected from the group consisting of aluminum, nickel, iron, copper, lead, zinc, chromium, tin and alloys made therefrom, with aluminum being preferred, and wherein the one or more metals and/or metal alloys are present in the mixture at a concentration of at least 1% (w/v) of the mixture.

### Example 2

An inflatable decorative or toy balloon as described in Example 1, wherein the one or more metals or metal alloys are in the form of platelets or flakes having a particle size of 1 to 50 microns.

### Example 3

A method of making a latex composition for use in making an inflatable decorative or toy balloon, method comprising the steps of: (1) providing a latex component consisting of natural rubber latex, synthetic latex and combinations thereof; (2) providing one or more weak acids; (3) providing one or more passivated metals and/or metal alloys selected from the group consisting of aluminum, nickel, iron, copper, lead, zinc, chromium, tin and alloys made therefrom, with aluminum being preferred, (4) providing one or more chelating agents; (5) mixing the one or more passivated metals and/or metal alloys in water to prepare an aqueous metal pigment slurry; (6) combining the aqueous metal pigment slurry with the one or more chelating agents to form a first mixture, wherein a concentration of the one or more passivated metals and/or metal alloys in the first mixture is 10 to 50% (w/v); (7) combining the latex component and the one or more weak acids to form a second mixture; (8) mixing the first mixture with the second mixture to form the latex composition, wherein the first mixture is about 5 to 15% by wet weight of the total latex composition.

### Example 4

An inflatable decorative or toy balloon as described in Example 3, wherein the one or more metals or metal alloys are in the form of platelets or flakes having a particle size of 1 to 50 microns.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

1. An inflatable decorative or toy balloon having a metallic finish, said balloon made from a latex composition comprising a mixture of:
(a) latex material selected from the group consisting of natural rubber latex, synthetic latex and combinations thereof,
(b) one or more metals and/or metal alloys in elemental form that have been passivated, said one or more metals or metal alloys being in the form of platelets or flakes with a particle size ranging from about 1 to 50 microns, and
(c) one or more metal and/or metal alloy ions complexed with a chelating agent.

2. The inflatable decorative or toy balloon of claim 1, wherein the one or more metals and/or metal alloys are present in the mixture at a concentration ranging from 1 to 20% (w/v) of the mixture.

3. The inflatable decorative or toy balloon of claim 2, wherein the one or more metals or metal alloys are present in the mixture in an amount ranging from 1 to 10% (w/v) of the mixture.

4. The inflatable decorative or toy balloon of claim 3, wherein the one or more metals or metal alloys are present in the mixture in an amount ranging from 1 to 5% (w/v) of the mixture.

5. The inflatable decorative or toy balloon of claim 1, wherein the one or more metals or metal alloys are selected from the group consisting of aluminum, nickel, iron, chromium, tin, antimony, magnesium, indium, platinum, silver, rhodium, palladium, zinc, cadmium, copper, gold, zinc, lead, titanium and alloys made therefrom.

6. The inflatable decorative or toy balloon of claim 5, wherein the one or more metals or metal alloys are selected from the group consisting of aluminum, nickel, iron, copper, lead, zinc, chromium, tin and alloys made therefrom.

7. The inflatable decorative or toy balloon of claim 6, wherein the one or more metals or metal alloys are selected from the group consisting of aluminum and aluminum alloys.

8. The inflatable decorative or toy balloon of claim 1, wherein at least 80% of any free, exposed or unpassivated metal or metal alloy ions in the composition are complexed with said chelating agent.

9. (canceled)

10. (canceled)

11. (canceled)

12. (canceled)

13. (canceled)

14. The inflatable decorative or toy balloon of claim 1, wherein the latex material is natural rubber latex.

15. The inflatable decorative or toy balloon of claim 1, wherein the synthetic latex is an elastomeric material simulating the properties of natural rubber latex.

16. The inflatable decorative or toy balloon of claim 15, wherein the synthetic latex is selected from the group consisting of polyisoprene, neoprene, chloroprene, polychloroprene, and combinations thereof.

17. An inflatable decorative or toy balloon having a metallic finish, said balloon formed from a latex composition, wherein the latex composition is prepared by a process comprising the steps of:
providing a latex component selected from the group consisting of natural rubber latex, synthetic latex, and combinations thereof;
providing one or more weak acids;
providing one or more metals and/or metal alloys in elemental form that have been passivated, said one or more metals or metal alloys being in the form of platelets or flakes with a particle size ranging from about 1 to 50 microns;
providing one or more chelating agents;
mixing the one or more metals and/or metal alloys in water to prepare an aqueous metal pigment slurry;
combining the aqueous metal pigment slurry with the one or more chelating agents to form a first mixture;
combining the latex component and the one or more weak acids to form a second mixture;
mixing the first mixture with the second mixture to form the latex composition.

18. The inflatable decorative or toy balloon of claim 17, wherein the latex component is natural rubber latex.

19. The inflatable decorative or toy balloon of claim 17, wherein the latex component is a synthetic latex that simulates the properties of natural rubber latex.

20. The inflatable decorative or toy balloon of claim 18, wherein the synthetic latex is selected from the group consisting of polyisoprene, neoprene, chloroprene, polychloroprene, or combinations thereof.

21. The inflatable decorative or toy balloon of claim 17, wherein the one or more chelating agents are provided in an amount of at least 0.8:1.0 chelating agent to predicted free, exposed and unpassivated metal ions.

22. (canceled)

23. (canceled)

24. The inflatable decorative or toy balloon of claim 17, wherein the one or metals and/or metal alloys are selected from the group consisting of aluminum, nickel, iron, copper, lead, zinc, chromium, tin and alloys made therefrom.

25. The inflatable decorative or toy balloon of claim 24, wherein the one or more metals and/or metal alloys are selected from the group consisting of aluminum and aluminum alloys.

26. The inflatable decorative or toy balloon of claim 25, wherein the one or more metals and/or metal alloys is aluminum.

27. The inflatable decorative or toy balloon of claim 17, wherein the one or more chelating agents is selected from the group consisting of ethylenediaminetetraacetic acid, neoalkoxy titanate, or combinations thereof.

28. The inflatable decorative or toy balloon of claim 17, wherein the one or more weak acids is selected from the group consisting of boric acid, glycine, carbonic acid, acetic acid, phosphoric acid, oxalic acid, hydrofluoric acid or combinations thereof.

29. The inflatable decorative or toy balloon of claim 17, wherein the one or more weak acids is selected from the group consisting of boric acid, glycine, or combinations thereof.

30. The inflatable decorative or toy balloon of claim 17, wherein a concentration of the one or more metals and/or metal alloys in the first mixture is 10 to 50% (w/v).

31. The inflatable decorative or toy balloon of claim 30, wherein the concentration of the one or more metals and metal alloys in the first mixture is 20 to 40% (w/v).

32. The inflatable decorative or toy balloon of claim 31, wherein the concentration of the one or more metals and metal alloys in the first mixture is 25 to 30% (w/v).

33. The inflatable decorative or toy balloon of claim 17, wherein an amount of chelating agent utilized is sufficient to chelate any unpassivated, exposed or free metal ions.

34. The inflatable decorative or toy balloon of claim 17, wherein the second mixture is adjusted to a pH of approximately 9.0 to 10.

35. The inflatable decorative or toy balloon of claim 34, wherein the second mixture is adjusted to a pH of approximately 9.3 to 9.9.

36. The inflatable decorative or toy balloon of claim 35, wherein the second mixture is adjusted to a pH of approximately 9.45 to 9.8.

37. The inflatable decorative or toy balloon of claim 17, wherein the first mixture is mixed with the second mixture to form a latex composition comprising the first mixture in an amount ranging from about 5 to 15% by wet weight of the latex composition.

38. The inflatable decorative or toy balloon of claim 37, wherein the first mixture is mixed with the second mixture to form a latex composition comprising the first mixture in an amount ranging from about 5 to 12% by wet weight of the latex composition.

39. The inflatable decorative or toy balloon of claim 38, wherein the first mixture is mixed with the second mixture to form a latex composition comprising the first mixture in an amount ranging from about 7 to 10.5% by wet weight of the latex composition.
